(19) United States
(12) Patent Application Publication
(10) Pub. No.: US 2026/0165537 A1
(43) Pub. Date: Jun. 18, 2026

(54) BURNABLE, INSECT-REPELLENT, CUTTING BOARD

(71) Applicant: Blaze Board, Fox River Grove, IL (US)

(72) Inventors: Charles SCHUTTE, Barrington, IL (US); Rohan VYAS, Fox River Grove, IL (US); Dylan RIFF, Barrington Hills, IL (US); Denis KUKOVSKI, Fox River Grove, IL (US); Jack JOHNSON, Barrington Hills, IL (US)

(21) Appl. No.: 18/982,961

(22) Filed: Dec. 16, 2024

(51) Int. Cl. A47J 47/00; A01M 29/12

(52) U.S. Cl. CPC A47J 47/005; A01M 29/12; A01M 2200/01

(57) ABSTRACT

A cutting board including a wooden board having a first flat side and a second flat side opposite the first flat side, and a side edge extending along a full perimeter of the wooden board between the first flat side and the second flat side. One or more holes are drilled into the side edge, and a natural insect repellent is inserted into the holes. The cutting board can be safely burned after use.

### BACKGROUND OF THE INVENTION

Outdoor cooking can be messy. One of the drawbacks of outdoor cooking, particularly when camping, is the need to pack all of the requisite cookware. After use, all of the cookware must be cleaned and then packed up and hauled back inside. Cleaning cookware while camping is often difficult if not impossible.

Another drawback of outdoor cooking, and camping in general, is the nuisance of insects. Spending time sitting around a campfire can be fun, but the fun diminishes when insects are present.

There is a need or desire for camping cookware that does not need to be cleaned. There is a further need or desire for a way to repel insects near a campfire.

### SUMMARY OF THE INVENTION

A cutting board, as described herein, is both burnable and provides insect-repellent properties when burned. The cutting board includes a wooden board having first and second flat sides and a side edge that extends along a full perimeter of the wooden board between the first and second flat sides. At least one hole is drilled into the side edge, and a natural insect repellent is inserted into the hole or holes. One or more plugs may be inserted into the hole or holes to keep the natural insect repellent in place. The plug may be wood, such as a wood dowel. The natural insect repellent may include lavender shavings.

The wooden board may be pine wood, and it may include a juice ring carved into one of the flat sides. The wooden board may be rectangular, having a length between about 9 and about 15 inches and a width between about 6 and about 12 inches. A thickness of the wooden board may be between about 0.5 inch and about 1.5 inches thick.

The wooden board may include between 2 and 8 holes drilled into the side edge. The holes may be between about 1 and about 7 inches deep. According to some embodiments, one or more of the holes may extend through the wooden board from a first location on the side edge to a second location on the side edge. The holes may have a diameter between about 0.125 inch and about 0.5 inch.

The wooden board may be finished with a layer of food-safe mineral oil. After the board has been put to use for cutting and/or arranging food, the board may be thrown into a fire, which releases insect-repellent properties by virtue of the natural insect repellent.

### BRIEF DESCRIPTION OF DRAWINGS

FIG. 1 is a perspective view of a cutting board.

FIG. 2 is a cross-sectional view of the cutting board in FIG. 1 taken along line 2-2.

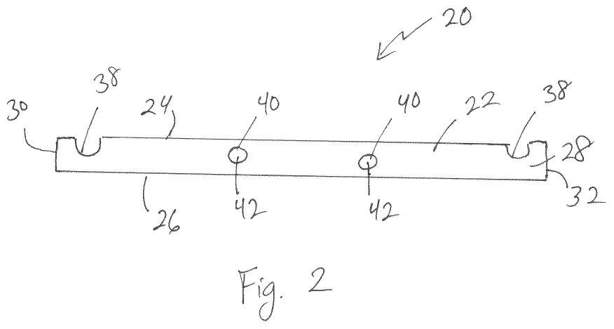

### DETAILED DESCRIPTION OF THE INVENTION

A cutting board, as described herein, is a multi-functional camping accessory that serves as both a cutting board and a natural insect repellent. The cutting board can be safely burned after use.

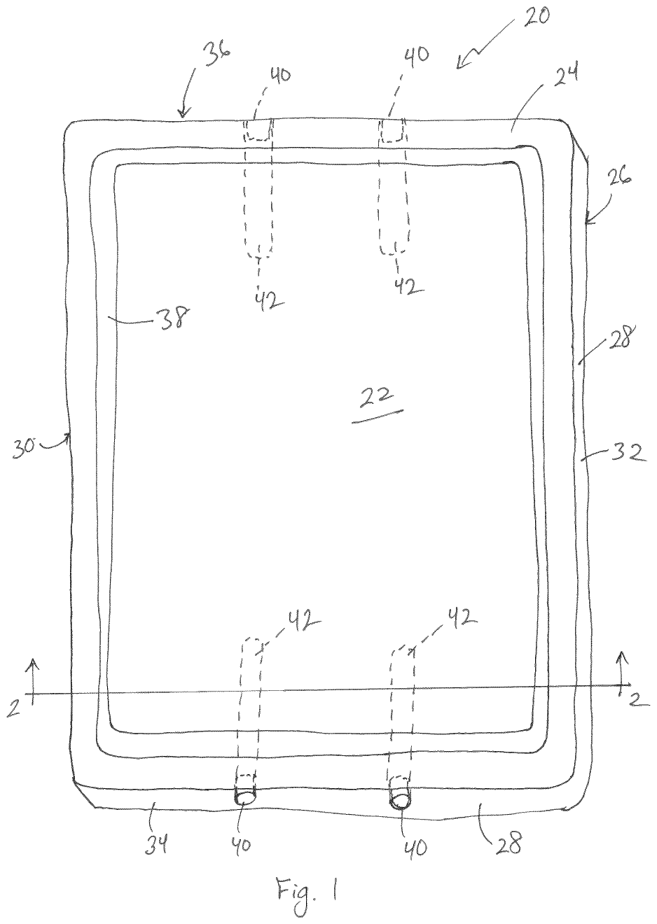

One embodiment of the cutting board 20 is shown in FIG. 1. The cutting board 20 is suitably made of wood, such as pine wood. Pine wood is lightweight, yet sturdy enough to serve as a surface on which to cut food, it is sustainable, and it burns well. The wooden board 22 can be rectangular or virtually any other shape having two flat sides 24, 26 opposite one another. A side edge 28 of the cutting board 20 extends along a full perimeter of the wooden board 22 between the two flat sides 24, 26. In the rectangular embodiment, the side edge 28 includes two longitudinal edges 30, 32 and two transverse edges 34, 36. Corners between the longitudinal edges 30, 32 and the transverse edges 34, 36 may be rounded or square. The longitudinal edges 30, 32 may be any suitable length, such as between about 9 inches and about 15 inches. The transverse edges 34, 36 may also be any suitable length, such as between about 6 inches and about 12 inches. The thickness of the wooden board 22 may be any suitable thickness, such as between about 0.5 inch and about 1.5 inches.

In one embodiment, for example, the cutting board 20 may be 12 inches long by 9 inches wide and 0.75 inch thick, with two smooth, flat surfaces 24, 26 for food preparation and with rounded edges and sides, achieved using a ⅛ inch router bit for safety and comfort. The wooden board 22 may also include a juice ring 38 carved into at least one of the flat sides 24 to catch any liquid runoff. The juice ring 38 may be formed using a ⅜ inch and 0.125 inch long round nose bit that carves a trough roughly 0.2 to 1 inch inward from the perimeter of the flat side 24.

The wooden board 22 also includes at least one hole 40 drilled into the side edge 28, with a natural insect repellent 42 inserted into the at least one hole 40. For example, the wooden board 22 may include between 2 and 8 holes 40. As shown in the embodiment in FIG. 1, the wooden board 22 may include 4 holes 40. The holes 40 may be drilled into one or both transverse edges 34, 36, or one or both longitudinal edges 30, 32, or in one or both transverse edges 34, 36 and one or both longitudinal edges 30, 32. The holes 40 may have a diameter between about 0.125 inch and about 0.5 inch, with a depth between about 0.5 inch and about 7 inches. For example, the holes 40 may have a diameter of 0.25 inch and a depth of about 4 inches. The holes 40 may be perpendicular to the edges 30, 32, 34, 36 in which they are drilled, or the holes 40 may be drilled at a non-right angle. The holes 40 are suitably spaced a distance from the closest edge orthogonal 30, 32, 34, 36 to the edge 30, 32, 34, 36 into which the holes 40 are drilled. The holes 40 may be spaced at least 1 inch or at least 2 inches or at least 3 inches from the closest orthogonal edge 30, 32, 34, 36. For example, the holes 40 may be drilled 2.5 inches from the closest orthogonal edge 30, 32, 34, 36. According to certain embodiments, one or more holes 40 may extend through the wooden board 22 from a first location on the side edge, such as on one of the transverse edges 34, 36, to a second location on the side edge, such as on the opposite transverse edge 36, 34.

As noted above, a natural insect repellent 42 is inserted into the hole 40 or holes 40. The natural insect repellent 42 may be lavender shavings, for example. After inserting the natural insect repellent 42 into the hole 40 or holes 40, a plug 44 is used to cover each hole 40. The plug 44 may be made of wood, such as a wooden dowel having approximately the same diameter as the hole 40.

The wooden board 22 can be finished with food-safe mineral oil to prevent the wood from drying out and cracking, and to provide a finished look. One or more layers of mineral oil can be applied to outer surfaces of the wooden board 22. The finished cutting board 20 can be used as a surface on which to cut virtually any food product. In addition to preparing food on the cutting board 20, the finished cutting board 20 can also be used as a surface on which to serve food.

After using the cutting board 20 for food preparation and/or serving, there is no need to clean the board 20. Instead, the cutting board 20 can be burned in a campfire for easy clean-up. The wooden board 22, plugs 44, and natural insect repellant 42 all burn safely and cleanly. Additionally, the natural insect repellent 42 in the wooden board 22 becomes active when burned. For example, when lavender shavings burn, they release a bug-repellent scent that keeps insects at bay, since insects generally do not like the smell of lavender. The wooden board 22 can burn for up to 15 to 20 minutes, with the lavender scent staying in the air for up to about 3 hours. Additionally, when burned, the cutting board 20 is safe to inhale and maintains its eco-friendly integrity, providing a safe and natural bug-repelling solution for campers and outdoor-cooking enthusiasts alike.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A cutting board comprising:
a wooden board having a first flat side and a second flat side opposite the first flat side, and a side edge extending along a full perimeter of the wooden board between the first flat side and the second flat side;
at least one hole drilled into the side edge; and
a natural insect repellent inserted into the at least one hole.

2. The cutting board according to claim 1, further comprising a plug covering the natural insect repellent in the at least one hole.

3. The cutting board according to claim 2, wherein the plug is wood.

4. The cutting board according to claim 1, wherein the natural insect repellent comprises lavender shavings.

5. The cutting board according to claim 1, wherein the wooden board is pine wood.

6. The cutting board according to claim 1, wherein the wooden board includes a juice ring carved into the first flat side.

7. The cutting board according to claim 1, wherein the side edge includes first and second longitudinal edges, and first and second transverse edges.

8. The cutting board according to claim 7, wherein the first and second longitudinal edges have a length between about 9 inches and about 15 inches.

9. The cutting board according to claim 7, wherein the first and second transverse edges have a length between about 6 inches and about 12 inches.

10. The cutting board according to claim 1, wherein a thickness of the wooden board between the first flat side and the second flat side is between about 0.5 inch and about 1.5 inches thick.

11. The cutting board according to claim 1, wherein the wooden board includes between 2 and 8 holes drilled into the side edge.

12. The cutting board according to claim 1, wherein the at least one hole is between about 0.5 inch and about 7 inches deep.

13. The cutting board according to claim 1, wherein the at least one hole extends through the wooden board from a first location on the side edge to a second location on the side edge.

14. The cutting board according to claim 1, wherein the at least one hole has a diameter between about 0.125 inch and about 0.5 inch.

15. The cutting board according to claim 1, further comprising a layer of mineral oil on the wooden board.
